(19) United States
(12) Patent Application Publication
(10) Pub. No.: US 2006/0107128 A1
(43) Pub. Date: May 18, 2006

(54) QoS control method, transmission apparatus and storage medium

(75) Inventors: Koji Matsunaga, Yokohama (JP); Shinji Takao, Yokohama (JP); Tatsuya Toyozumi, Yokohama (JP); Hidetoshi Amari, Kawasaki (JP); Junichi Sawada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/054,556

(22) Filed: Feb. 10, 2005

(30) Foreign Application Priority Data
Oct. 8, 2004 (JP) 2004-296355

(51) Int. Cl. H03M 13/00

(52) U.S. Cl. 714/709

(57) ABSTRACT

An automatic detection of failure occurrence on a network and selection of QoS table defining a priority for communication among the nodes constituting the network in response to a degeneracy situation of the network caused by the failure upon detection thereof make communications among the nodes by using the selected QoS table.

### BACKGROUND OF THE INVENTION

1. Field of the Invention

The present invention relates to a technique for assuring a quality of service (“QoS” hereinafter) by ensuring respective nodes communicate with one another based on a QoS table defining priority for communications among the nodes constituting a network.

2. Description of the Related Art

In recent years, QoS control has been adopted for increasingly effective use of a limited network resource (i.e., bandwidth). The QoS control is a technique for firmly securing a response time and a throughput required for respective communications through an optimum resource allocation in accordance with the purpose of communications taking place in the nodes constituting a network.

The amount of resource and the related priority required for communications among the nodes constituting a network are usually predictable, which has recently prompted the creation of a QoS table for identifying priority for communications among nodes to allocate the resource in reference to the table. A QoS control-applicable network using the QoS table is for instance disclosed in a published Japanese patent application 2002-171268.

In a network disclosed by the above document, a node (transmission apparatus) constituting the network operates as a terminal or an intermediate station. A node operating as a terminal station performs QoS control.

In a network, a failure may occur in a node or a transmission line. Occurrence of a failure causes degeneration of the network, changing the communicable area. In an attempt to automatically adapt to the change, each of the nodes constituting a network described by the published Japanese patent application 2002-171268 is configured to recognize the network structure by a token packet and operate automatically either as a terminal or an intermediate station according to the aforementioned recognition. Each node stores identification data (i.e., address) to indicate own node in the token packet and transmits so that the network structure is recognizable.

In the case of a network capable of two-way communications, communication between nodes with a variable time for communication occurs depending on the location of the failure. A QoS table for use before failure occurrence is not necessarily optimal for use after a failure occurrence since the table is constructed under the assumption of no failure. A QoS table used for QoS control, however, has conventionally been changed manually by an operator, which has the inherent problem of taking a long time until an optimal QoS control becomes performable from a failure occurrence. As such, a timely resumption of optimal QoS control is desired.

### SUMMARY OF THE INVENTION

The purpose of the present invention is to provide a technique for speeding up an optimal QoS control in response to failure.

A QoS control method according to the present invention secures quality of service by making nodes communicate with one another based on a QoS table defining a priority relative to communications among the nodes constituting a network, in which the QoS control detects a failure occurrence on a network, selects a QoS table in response to a degeneracy situation of the network caused by the failure if and when the failure is detected, and make the nodes communicate with one another according to the selected QoS table.

A transmission apparatus according to the present invention, assuming to be used for a node constituting a network being capable of a two-way communication, comprises a QoS control unit for performing a QoS control for controlling a communication among the nodes based on a QoS table defining a priority for communications among the nodes constituting the network; a structure recognition unit for recognizing a structure of the network; a control manager unit for making the QoS control unit per form a QoS control on as required basis according to a recognition result provided by the structure recognition unit; a failure detection unit for detecting a failure occurrence on the network based on a recognition result provided by the structure recognition unit; and a table provision unit for providing a QoS table to be used for the QoS control when the failure detection unit detects a failure which requires the control manager unit to make the QoS control unit perform the QoS control.

A QoS control management apparatus according to the present invention, which is an apparatus for making a transmission apparatus control a communication among nodes constituting a network being capable of a two-way communication based on a QoS table defining a priority for a communication among the nodes, comprises a failure detection unit for detecting a failure occurrence on the network; a degeneracy degree recognition unit for recognizing a degeneracy situation of the network caused by the aforementioned failure upon detecting a failure by the failure detection unit; a table selection unit for selecting a QoS table to be used for the communication control based on a recognition result provided by the degeneracy degree recognition unit; and a table provision unit for providing a QoS table selected by the table selection unit to the transmission apparatus.

A first aspect of a storage medium according to the present invention is stored with a program for making a transmission apparatus for use as a node constituting a network being capable of a two-way communication operate. The program makes the transmission apparatus accomplish the functions of performing a QoS control for controlling a communication among the nodes based on a QoS table defining a priority for communications among the nodes constituting the network; recognizing a structure of the network; making the function of performing a QoS control perform a QoS control on as required basis based on a recognition result provided by the recognizing function; detecting a failure occurrence on the network based on a recognition result provided by the recognizing function; and providing a QoS table to be used for the QoS control when the detecting function detects a failure which requires the making function to let the performing function perform the QoS control.

A second aspect of a storage medium according to the present invention is stored with a program for making a QoS control management apparatus let a transmission apparatus perform a communication control among nodes, constituting a network being capable of a two-way communication, based on a QoS table defining a priority for communications among the nodes. The program makes the QoS control management apparatus accomplish the functions of detecting a failure occurrence on the network; recognizing a degeneracy situation of the network caused by the aforementioned failure upon detecting a failure by the failure detecting function; selecting a QoS table to be used for the communication control based on a recognition result provided by the recognizing function; and providing a QoS table selected by the selecting function to the transmission apparatus.

The present invention detects automatically a failure occurrence on a network and selects automatically a QoS table defining a priority for communications among the nodes constituting the network in response to a degeneracy situation of the network caused by the failure. This makes it possible to commence an optimal QoS table more quickly in response to the occurring failure.

### BRIEF DESCRIPTION OF THE DRAWINGS

FIG. 1 shows an example of a network comprised by using a transmission apparatus according to the present embodiment as a node;

FIG. 2 shows a configuration of a transmission apparatus according to the present embodiment;

FIG. 3 shows a functional structure of a token controller constituting a transmission apparatus and of a control part;

FIG. 4A shows the data structure of packet trailer;

FIG. 4B shows the data structure of packet being stored in a packet trailer;

FIG. 5 shows a data structure being stored in a token packet under no failure occurrence;

FIG. 6 shows an address sequence being stored in a token packet under a failure occurrence;

FIG. 7 shows a priority for communications among nodes under a failure occurrence;

FIG. 8 shows an example of QoS table used under no failure occurrence;

FIG. 9 shows an example of QoS table used under a failure occurrence;

FIG. 10 shows how a relative priority is defined in the same priority class;

FIG. 11 shows an example of table for selecting a QoS table;

FIG. 12, shows a process flow chart for selecting a QoS table.

### DESCRIPTION OF THE PREFERRED EMBODIMENTS

A preferred embodiment according to the present invention is described in detail while referring to the accompanying drawings as follows.

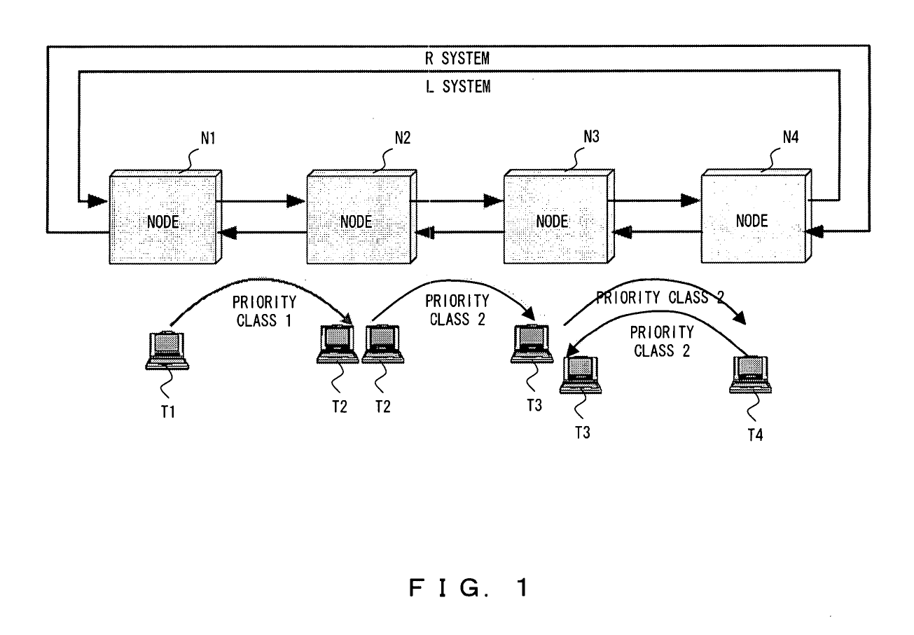

FIG. 1 shows an example of a network comprised by using a transmission apparatus according to the present embodiment as a node.

The network as shown by FIG. 1 is structured by connecting nodes N1 through N4 in a ring. Each adjacent node N is connected by two-way transmission line. Let it be defined here that the direction for data communication between the nodes in the sequence of “N4 to N3 to N1 back to N4” is called an “R system,” while the direction thereof in the sequence of “N1 to N2 to N3 to N4 back to N1” is called an “L system.”

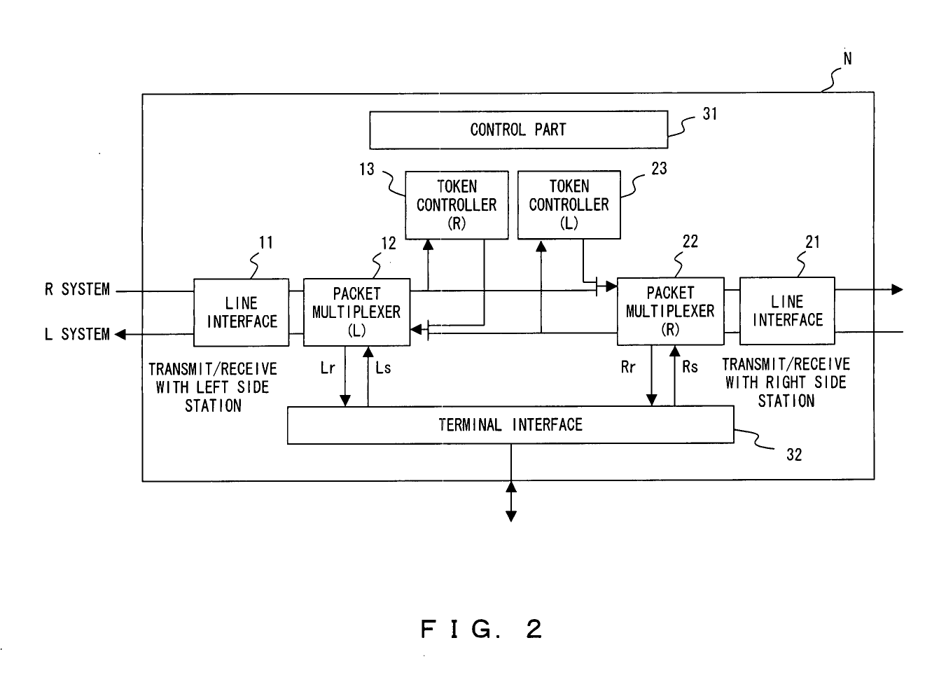

FIG. 2 shows a configuration of transmission apparatus (i.e., node) N according to the present embodiment.

The node N is capable of operating as a terminal station performing QoS control and an intermediate station not performing the control, as a transmission apparatus noted in the published Japanese patent application 2002-171268. The node N is comprised by equipping a function which recognizes a failure occurrence and selects a QoS table automatically for use in a QoS control responding to the recognized nature of the failure occurrence in addition to the transmission apparatus noted in the aforementioned patent publication. As shown by FIG. 2, the node N comprises line interfaces 11 and 21, packet multiplexers (PMUX) 12 and 22, token controllers (TCNT) 13 and 23, a control part (CNT) 31, and a terminal interface (IF) 32.

The line interface 11 receives a signal transmitted on the R system transmission line and transmits a signal being destined for transmitting on the L system transmission line. The line interface 21, conversely, receives a signal transmitted on the L system transmission line and transmits a signal being destined for transmitting on the R system transmission line. Each of the line interfaces 11 and 21 is connected with the packet multiplexers 12 and 22, respectively.

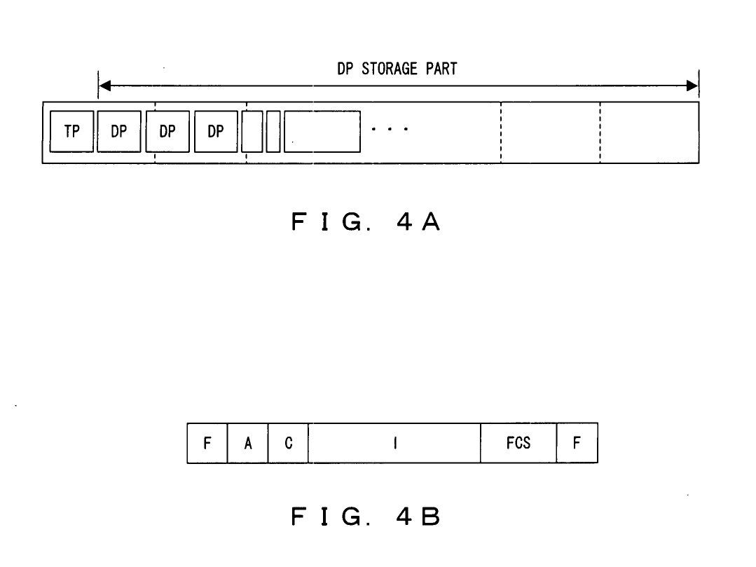

FIG. 4A shows the data structure of a packet trailer; and FIG. 4B shows the data structure of packet being stored in the packet trailer.

In the packet trailer as shown by FIG. 4A, a token packet TP is stored at the front, followed by data packets DP, a succession of which are closely packed together in sequence, for transmitting by each node. A control packet CP for controlling communications among nodes is stored behind the token packet TP as appropriate.

Each packet for instance is configured by a format in compliance with the HDLC (high-level data control procedures). As shown by FIG. 4B, each packet comprises a flag field F, an address field A, a control field C, an information field I and a frame check sequence field FCS. Identification data for indicating packet types such as the token packet TP, the data packet DP or the control packet CP and priority information for indicating a priority of transmission data are stored in the control field C.

The above described packet trailer is transmitted to the R and L systems, respectively, which is received by the respective interfaces 11 and 21.

The packet multiplexer 12 outputs the received signal in the R system (i.e., packet trailer) outputted from the line interface 11 to the token controller 13, and in particular, if the packet trailer includes a data packet DP addressed to the node of its own, then the packet multiplexer 12 extracts the packet DP and outputs data Lr included therein to the terminal interface 32. Data Ls input from the interface 32 as being destined for transmission is stored in the packet trailer and then transmitted. The terminal interface 32 is connected to a terminal apparatus T. In FIG. 1, though not shown the terminal apparatus labeled T1 is connected with a node N1. The same labeling rule applies to the other terminal apparatus T2 through T4.

Storing data Ls in a packet trailer is done if the trailer has spare space, while if there is no space, and if its own node is operating as an intermediate station, then a transmission request, in place of the data Ls, will be stored in a token packet TP for instance, whereas if operating as the terminal station, then the data Ls will be stored according to an instruction from the token controller 13. In the transmission request, a node N is identified as the designated receiver in addition to its own node as the transmitter.

In the token packet TP, an area is set aside for each node N storing the own address. The packet multiplexer 12 also stores the address in the area corresponding to its own node. The same is done in the packet multiplexer 22 on the other side.

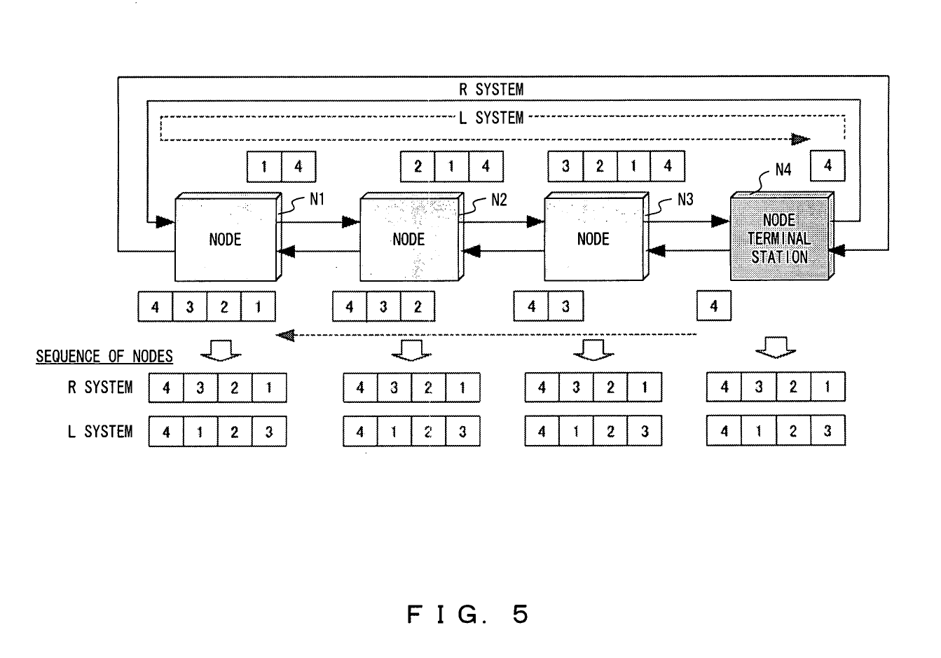

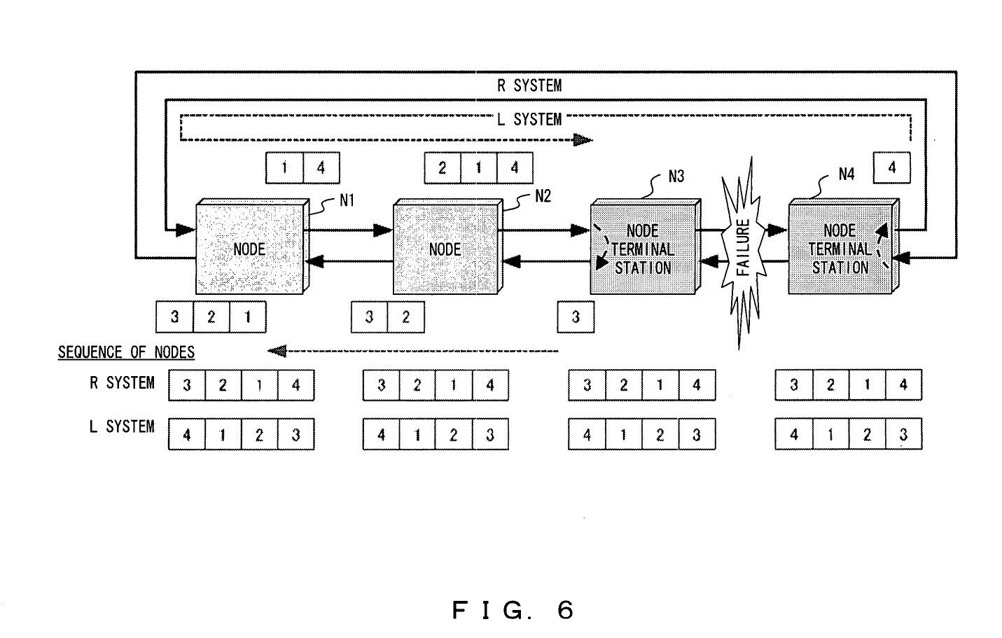

Now referring to FIGS. 5 and 6, a recognition method for a network structure is described specifically.

FIG. 5 describes a data structure being stored in a token packet under no failure occurrence. This is based on the assumption that the node N4 is presently operating as the terminal station. The numbers “1” through “4” denote the addresses of the nodes N1 through N4 respectively. The same naming rule also applies to FIG. 6.

The node N4 operating as the terminal station is generated the packet trailers and output to the transmission lines for the L and R systems respectively. Following the address stored by the node N4, the addresses of N1, N2 and N3 are stored in sequence in the token packet of the packet trailer for the L system. As a result, the node N4 will actually receive the packet trailer in which these addresses are stored in the token packet TP. While in the R system, the node N4 will actually receive the packet trailer in which the address stored by the node N4, followed by the addresses of N3, N2 and N1 are stored in the aforementioned sequence in the token packet.

When a failure occurs on a transmission line or in a node N, the sequence of addresses being stored in the token packet TP changes. Depending on the position and number of failures, the number of stored addresses also changes. This makes it possible to recognize a network structure through an analysis of a sequence of addresses stored in a token packet TP.

FIG. 6 describes an address sequence being stored in a token packet under a failure occurrence. This is based on the assumption that a failure has occurred in each transmission line between the nodes N3 and N4.

Under such a failure occurrence, the node N3 operates as a terminal station in addition to the node N4. In this case, however, the node N4 only generates and transmits a packet trailer for the L system. It is the node N3 that generates and transmits a packet trailer for the R system. This causes the address sequence stored in the token packet TP in the R system to change upon occurrence of the failure. That is, the address of a node N operating as the terminal station, which is stored first, changes. The sequence of the addresses of N4, N3, N2 and N1 changes to a sequence of the addresses of N3, N2, N1 and then N4. This makes it possible to recognize a network structure (including the topology) after a failure occurrence and the position thereof through an analysis of the address sequence (i.e., a sequence of nodes) in each of the R and L systems.

When a failure occurs, a node N located downstream of the failed position can no longer receive a packet trailer. The packet trailer is generated and transmitted at a prescribed interval. Therefore, monitoring the reception of packet trailers makes it possible to detect a node N located downstream of a location of a failure occurrence.

The present embodiment lets the node N which has detected a failure transmit a signal (called “master notice frame”) signaling that it is operating as the terminal station and another node located upstream of the failure transmits a master invitation frame, as noted in the published Japanese patent application 2002-171268. The master invitation frame causes the node operating its own node as the terminal station to detect a recovery from the failure and change itself to anode corresponding to the recovery.

The above described failure detection and recognition of a network structure is performed by the control part 31. The control part 31 performs QoS control in the operation mode of processing a transmission request stored in the token packet TP of a packet trailer when operating its own node as the terminal station. Consequently, QoS control is performed only under conditions of relatively heavy traffic.

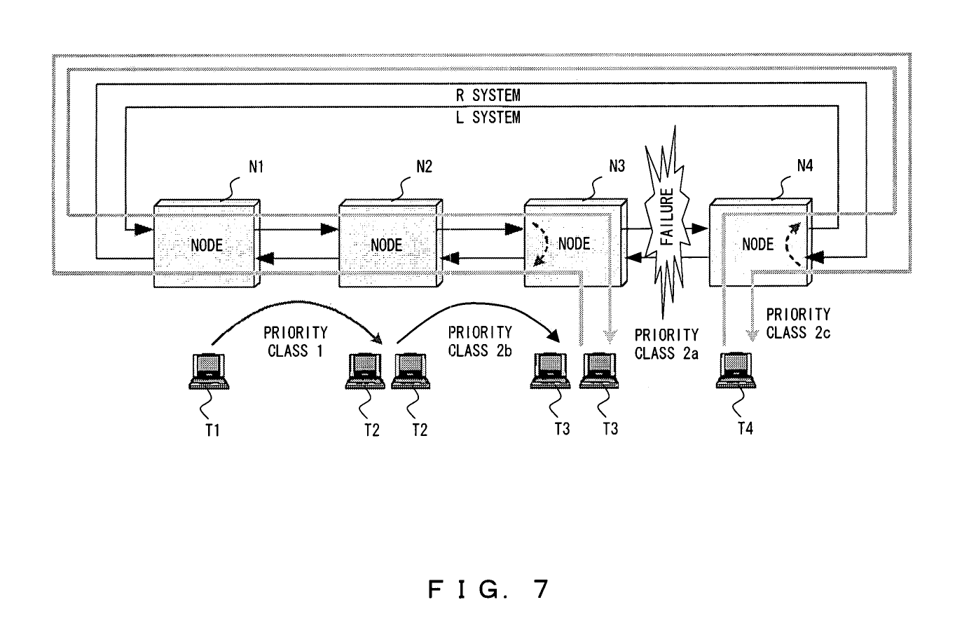

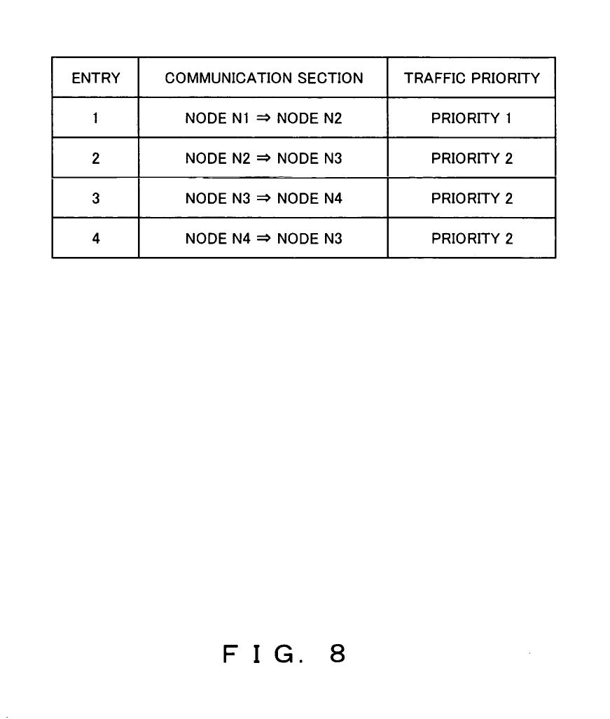

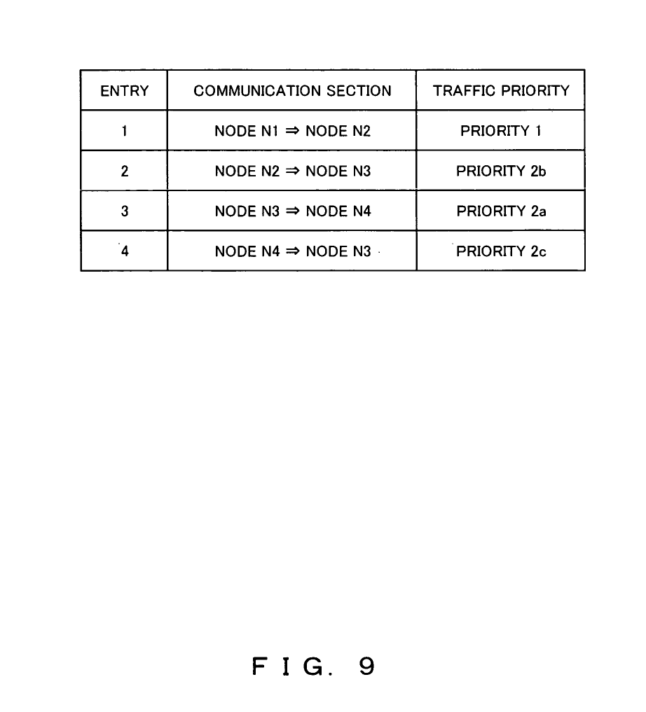

The above QoS control is performed by using a QoS table defined by priority in relation to communications between nodes constituting a network. FIG. 8 shows an example of QoS table used under no failure occurrence; and FIG. 9 shows an example of QoS table used under a failure occurrence. FIG. 9 shows a case where a failure has occurred in the two transmission lines between the nodes N3 and N4 as shown by FIG. 6. Control by using the QoS table shown by FIG. 9 changes the priority for communications between the respective nodes in response to the failure occurrence to that shown by FIG. 7.

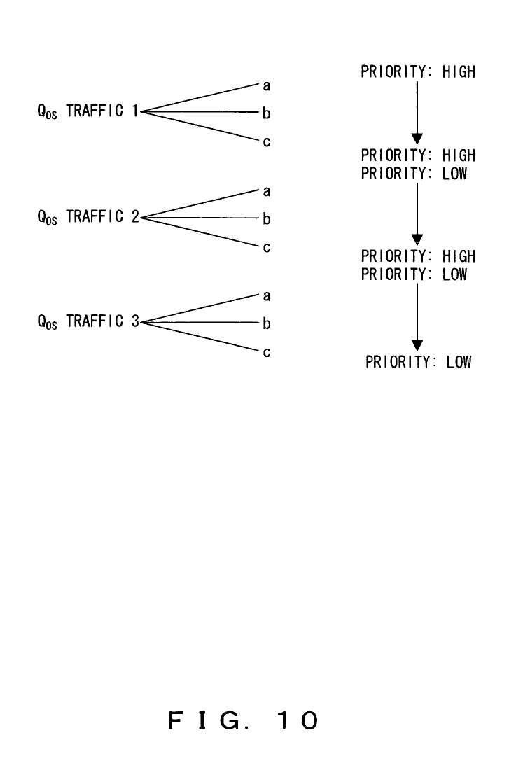

In FIGS. 8 and 9, the traffic priority is higher when the number is smaller. That is, the “priority 1” is higher priority than the “priority 2.” Postfixes “a” through “c” attached to “priority 2” represent a higher or lower priority within the same priority as shown by FIG. 10.

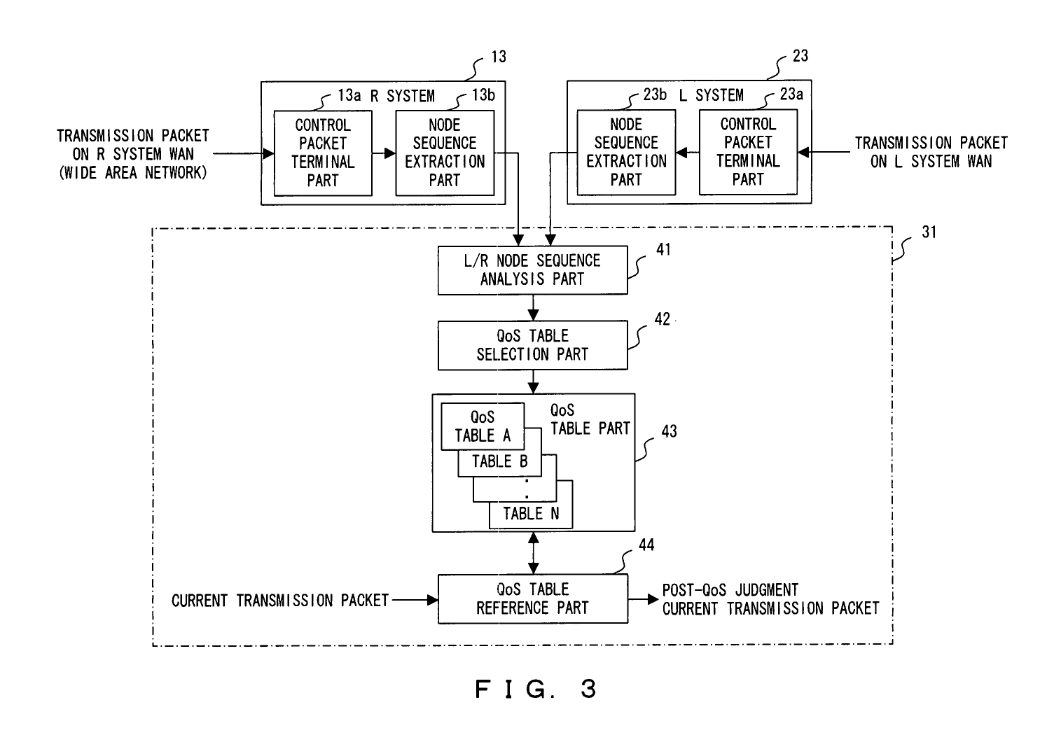

FIG. 3 shows a functional structure of a token controller and a control part.

A token controller 13 comprises a control packet terminal part 13a for receiving a packet trailer of the R system from the packet multiplexer 12, and a node sequence extraction part 13b for receiving a token packet TP in a packet trailer from the control packet terminal part 13a and extracting a node N address (i.e., data indicating a sequence of nodes N constituting a network) and a transmission request being stored in the token packet. The extracted node N address and transmission request are then sent to the control part 31. The same goes with the token controller 23 on the L system.

If the network topology is a ring, each of the token controllers 13 and 23 sends out an address, while, if the topology is linear, either one of the two sends out the address.

An L/R node sequence analysis part 41 equipped in the control part 31 analyzes a node N address extracted by a node sequence extraction parts 13b and 23b residing in the token controllers 13 and 23, respectively, and recognizes (i.e., specifies) the sequence and topology of node N constituting the network; and in addition, monitors timing of the data transmitted from the token controllers 13 and 23 in order to judge whether or not its own node shall be operated as the terminal station, as described above. These results will be sent to a QoS table selection part 42.

Stored in a QoS table part 43 is a plurality of QoS tables for performing a QoS control when the node N is operating as the terminal station. These QoS tables are prearranged in response to the position of failure (i.e., a sequence of the nodes indicating the network structure as a result of degeneration thereof induced by the failure). The QoS table selection part 42, upon receiving a judgment to operate its own node as the terminal station, selects the QoS table corresponding to the node N sequence. During the time when the judgment for operating its own node as the terminal station is maintained, the QoS table selection part 42 selects a QoS table when a sequence of nodes N received from the token controller 13, or 23, changes.

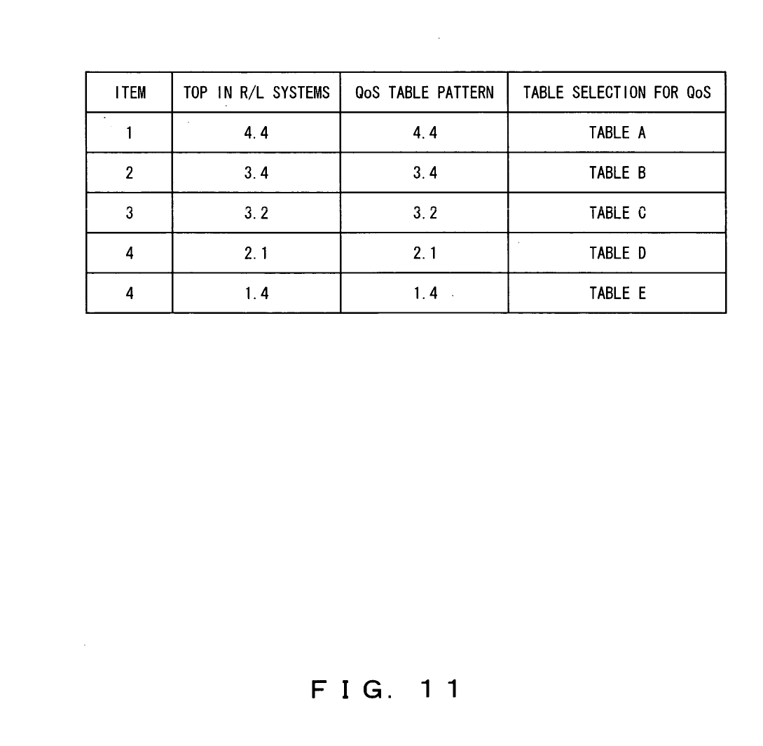

FIG. 11 shows an example of table for selecting a QoS table prepared for selecting a suitable table being stored in the QoS table part 43. The information being stored as “Top position in L/R system sequence” (noted “4, 4,” et cetera, in FIG. 11) corresponds to a combination of addresses of nodes N located in the top positions within those of the L and R systems, respectively, which are detected by the token controller 13 and 23 respectively. The information being stored as “Table selection for QoS” (e.g., “Table A” shown in FIG. 11) indicates a QoS table supposedly for being selected in response to the aforementioned combination. The information being stored as “QoS table pattern” (noted “4, 4,” et cetera, in FIG. 11) indicates a combination of addresses of nodes N to be selected in accordance with the aforementioned combination. The QoS table part 43 selects a QoS table in reference to the table of QoS table selection as exemplified by FIG. 11.

A QoS table reference part 44 performs a QoS control in reference to a QoS table being selected by the QoS table selection part 42. In the QoS control, if there are a plurality of nodes N respectively requesting for a data transmission by issuing a transmission request via a communication line (i.e., between nodes needing communication) being specified, the QoS table reference part 44 accepts a transmission request from the node N specifying the communication line being identified as the highest priority among such nodes, generates a packet trailer readily securing a reserved section for the aforementioned node N storing a data packet and lets each of the packet multiplexers 12 and 22, respectively, transmit the packet trailer.

As such, the present embodiment, upon occurrence of a failure, detects the failure automatically, selects an optimal QoS table automatically in response to the degeneracy situation of the network caused by the failure and reflects it on the QoS control. This makes it possible to commence quickly the most optimal QoS control at any time in response to the occurring failure, which in turn makes it possible to avoid a non-uniform traffic condition caused by the failure, thus enabling to provide a continuously effective network service.

Creation of QoS table is basically aimed at providing a real time service as the highest priority, which requires a low probability of delays and a high quality, a real time service as a next priority, which requires a relatively low probability of delays and medium quality, and a non-real time service as the lowest priority.

In a case where a network is used for monitoring equipments, the network is generally designed to have a bandwidth being capable of communicating the monitoring control packets free of problem. This tends to define a QoS table as relatively lower priority. Such QoS table, however, if used after a failure occurrence, will result in a very undesirable situation where a non-prioritized packet is unlikely to be sent because the highest priority packets take precedence.

In consideration of such a situation, a countermeasure may be considered for setting the bandwidth low in advance or placing the monitoring control packets at a higher priority. However, the former hampers effective use of bandwidth. The latter creates fluctuation caused by burst-like transmissions of the monitoring control packets in the packet transmission and the fluctuation may degrade a quality of the network. Either of the countermeasures hence creates other problems. Such problems are in fact avoidable by readily preparing the most optimal QoS table in response to each situation in advance and selecting the most suitable QoS table for the situation.

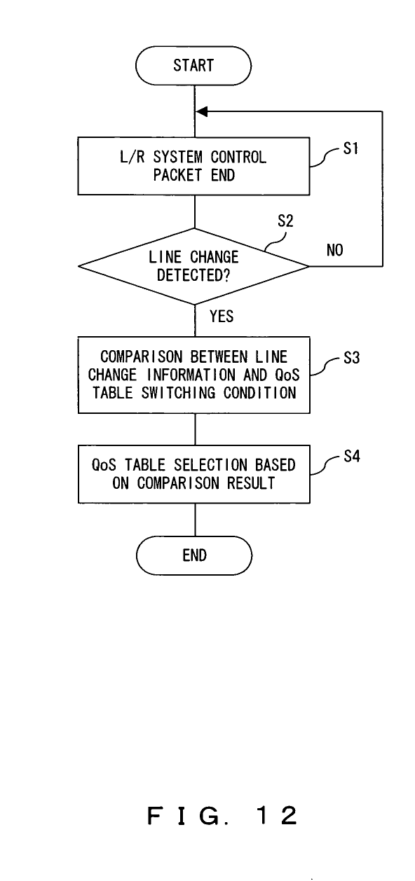

FIG. 12 shows a process flow chart for selecting a QoS table. FIG. 12 shows a summary flow chart of a process which is performed by the control part 31 for selecting a QoS table for a QoS control from among the ones being stored in the QoS table part 43. The selection process is then described in reference to FIG. 12. The selection process is accomplished for example by a CPU as a component in the control part 31 operating for example a program being stored in a memory being used as the QoS table part 43. Each of the functions of the L/R node sequence analysis part 41, the QoS table selection part 42 and the QoS reference part 44 are accomplished by the CPU executing the aforementioned program.

First in the step S1, the node N addresses extracted by the token controllers 13 and 23 are obtained. In the following step S2, the obtained addresses are analyzed to judge whether or not the network structure has changed by the occurring failure. If there is a change in the addresses (i.e., the top address) of node N obtained from either of the token controllers 13 and 23, the judgment is “yes,” indicating a change in the network structure, thereby moving the process to the step S2. Otherwise the judgment is “no,” thus moving the process back to the step S1. Moving to the step S3 means to only operate its own node as the terminal station.

In the step S3 the QoS table selection table shown by FIG. 11 is referred to by using a combination of node N addresses (i.e., combination of the top addresses) obtained from each of the token controllers 13 and 23. A series of processes is completed with the aforementioned selection.

Note that the present embodiment is such that each of the nodes N constituting a network is respectively storing a plurality of QoS tables for readily selecting a QoS table automatically in response to a failure occurrence. Specifically, a manager server maybe made available for managing the QoS tables for a QoS control to let the manager server detect a failure and select a QoS table upon failure detection. The manager server may be connected with a network where the inter-node N communications take place, or connected with the respective nodes N by way of another network. Also a table used for QoS control may be provided to the requiring node N as required.

A program for accomplishing the node N (i.e., transmission apparatus) or the manager server as described above may be distributed by storing it on a storage medium such as CD-ROM, DVD, or detachable flash memory. Also, a part or the whole of the program may be provided by way of a network. In such cases, the user is able to obtain the program to load on the existing transmission apparatus, thereby applying the present invention to the apparatus. For this reason, an applicable storage medium may be accessible by an apparatus for providing the program.

What is claimed is:

1. In a QoS control method for securing a quality of service by making nodes communicate with one another based on a QoS table defining priorities for communications among the nodes constituting a network, including the steps of:
detecting a failure occurrence on the network;
selecting the QoS table in response to a degeneracy situation of the network caused by the failure upon detection of a failure; and
making the nodes to communicate with one another based on the selected QoS table.

2. In a transmission apparatus being used as a node constituting a network being capable of a two-way communication, comprising:
a QoS control unit for performing a QoS control for controlling a communication among the nodes based on a QoS table defining a priority for communications among the nodes constituting the network;
a structure recognition unit for recognizing a structure of the network;
a control manager unit for making the QoS control unit perform QoS control on as required basis according to a recognition result provided by the structure recognition unit;
a failure detection unit for detecting a failure occurrence on the network based on a recognition result provided by the structure recognition unit; and
a table provision unit for providing a QoS table to be used for the QoS control when the failure detection unit detects a failure which requires the control manager unit to make the QoS control unit perform the QoS control.

3. The transmission apparatus in claim 2, wherein said structure recognition unit recognizes the structure of said network from a packet in which each node stores identification data indicating its own node to transmit.

4. A QoS control management apparatus for making a transmission apparatus control communication among nodes constituting a network being capable of a two-way communication based on a QoS table defining priority for communications among the nodes, comprising:
a failure detection unit for detecting a failure occurrence on the network;
a degeneracy situation recognition unit for recognizing a degeneracy situation of the network caused by the failure when the failure detection unit detected the failure;
a table selection unit for selecting a QoS table to be used for communication control based on a recognition result provided by the degeneracy degree recognition unit; and
a table provision unit for providing a QoS table selected by the table selection unit to the transmission apparatus.

5. A storage medium storing a program for executing a transmission apparatus for use as a node constituting a network being capable of two-way communication to operate, wherein a program is stored for accomplishing the functions of:
performing QoS control function controlling communication among nodes based on a QoS table defining priority for communications among the nodes constituting the network;
recognizing function recognizing structure of the network;
making function making the performing QoS control function to perform QoS control as required based on a recognition result provided by the recognizing function;
detecting function detecting a failure occurrence on the network based on a recognition result provided by the recognizing function; and
providing function providing the QoS table to be used for the QoS control when the detecting function detects a failure which requires the making function to make the performing QoS control function perform the QoS control.

6. A storage medium storing a program for executing a QoS control management apparatus make a transmission apparatus perform a communication control among nodes, constituting a network being capable of a two-way communication, based on a QoS table defining a priority for communications among the nodes, wherein the program is stored for accomplishing the functions of:
detecting function detecting a failure occurrence on the network;
recognizing function recognizing a degeneracy situation of the network caused by the failure detecting by the detecting function;
selecting function selecting the QoS table to be used for communication control based on a recognition result provided by the recognizing function; and
providing function providing the QoS table selected by the selecting function to the transmission apparatus.
